(19) United States
(12) Patent Application Publication
(10) Pub. No.: US 2008/0185059 A1
(43) Pub. Date: Aug. 7, 2008

(54) Traverse motion HVAC valve

(75) Inventors: Gregory J. Kowalski, Sanborn, NY (US); Gerald Michael Goupil, North Tonawanda, NY (US)

Correspondence Address: DELPHI TECHNOLOGIES, INC., M/C 480-410-202, PO BOX 5052, TROY, MI, 48007, US

(73) Assignee: DELPHI TECHNOLOGIES, INC., Troy, MI (US)

(21) Appl. No.: 11/702,262

(22) Filed: Feb. 5, 2007

(51) Int. Cl. F16K 11/07

(52) U.S. Cl. 137/625.42

(57) ABSTRACT

A pair of rotary valves for opening and closing two outlets of an HVAC system. A shaft has oppositely threaded and axially spaced sections each engaging one of the valves for moving the valves axially. Each valve includes a guide plate defining an upper surface curved along the periphery of one of the outlets to define a guide for limiting rotational moving of each valve in response to rotation of the shaft. Each guide plate defines a lower surface that is a contoured shape and parallel to the axis for directing air flow through each outlet.

### BACKGROUND OF THE INVENTION

1. Field of the Invention

The invention relates to a climate control system also commonly referred to as an HVAC system (heating, ventilation, and air conditioning) for a vehicle and more specifically to a valve assembly for controlling airflow through an outlet of the climate control system.

2. Description of the Prior Art

Conventional heating, ventilation and air conditioning (HVAC) systems for vehicles generally include a housing, an evaporator, a heater core having a housing, an evaporator assembly coupled to the housing, an evaporator, a heater core, an air inlet, a fan and various doors or mode valves for controlling the volume and direction of air flow and generating outlet air of a desired volume and temperature. Together these components receive, temper and direct the flow of forced air through several outlets or vents in the vehicle. The outlets through which the forced air ultimately exits are determined by the various doors which move between open and closed positions and cause air flow to be forced in one direction or another or a combination of both. Air may be directed to various areas of the car depending on the state of the mode valves. For example, air may be forced through outlets directed at the windshield in a defrost or defog mode, or through outlets directed at mid-height level in an air-conditioning mode, or to lower outlets directed to the floor in a heat mode, or various combinations thereof. Generally, designs have been utilized in which the housing has a plurality of outlets each having a periphery. More recently, the housing is defined by two oppositely facing outlets. A motor or mechanism is attached to a shaft that is rotatably supported by the housing outside the peripheries of the outlets. A rotary plate valve is disposed about the shaft and is movable to cover or block air from exiting the outlets in a closed position and uncover or unblock the outlets to permit air to exit the housing in an open position. The plate valve's periphery is connected to the shaft and the plate valve is covered with material which complies with the interior of the housing in order to form an air seal. This material generally is made from a compressible cellular foam or molded thermoset rubber that forms a wiper. As the shaft rotates, the plate valve rotates with the shaft so that the foam or rubber attached to the plate valve seals the outlets.

These rotary plate valves require the plate and its seal to be in sliding contact with the housing when alternating between the open and closed positions. Such a sliding valve requires relatively high contact pressure in order to compress the foam or deform the rubber wiper in order to achieve a desired seal.

Furthermore, these rotary plate valves rely on a torque limited motor to rotate the shaft end either directly or remotely via a cam, link and lever in order to move the valve plate to the open and closed positions. When the contact pressure is too high for the motor to overcome, the plate valve can become immobilized in an undesired position and may result in failure of the motor. HVAC systems having these rotary plate valves do not have a means to direct the cold air from the evaporator core and hot air from the heater towards the outlet in order to achieve a desired outlet temperature while in an open position. Additionally, these rotary plate valves do not have a means to meter a portion of these airstreams while in an intermittent position between open and closed. These intermittent positions are desired in order to achieve the proper air balance between the various outlets such as the lower outlets directed to the floor in a heat mode.

Examples of rotary valves in HVAC systems are included in U.S. Pat. No. 4,683,913 to Hoffman et al. and U.S. Pat. No. 5,009,392 to Ostrand.

Hoffman et al. teach a rotary valve for sealing outlets defined by a curved surface. The air valve has a radius of curvature measured from an axis which is offset from that of the radius of curvature for the surface defining the outlets being sealed. This valve's plate and sealing surface which cover or uncover an outlet are parallel with the axis of the shaft and as such is only able to seal an outlet that is located parallel with the axis of the shaft. The contact pressure is therefore high when the valve is in a closed position and diminishes to zero after the valve is rotated to an open position.

Although the prior art provides valves which move between open and closed positions, there remains a need for a valve that does not produce high frictional loads while simultaneously aiding in directing air flow through the outlet of the housing. Furthermore, there also remains a need for a valve that can direct the cold air from the evaporator core and hot air from the heater towards the outlet in order to achieve a desired outlet temperature and can meter a portion of these airstreams while in an intermittent position between open and closed. Additionally, there remains a need for a rotary valve whose plate and sealing surface is perpendicular to the shaft.

### SUMMARY OF THE INVENTION AND ADVANTAGES

The invention provides such an assembly for controlling air flow in an HVAC system wherein the rotatable shaft has a threaded section. The interior surface of the plate valve is threaded and is in threaded engagement with the threaded section of the shaft for moving the plate valve axially away from the outlet in response to rotation of the shaft in a first direction and moving the first plate valve axially toward the outlet in response to rotation of the shaft in a second direction opposite to the first direction while the plate valve is kept from rotating due to its relative engagement with the outlet.

The invention provides a valve which uses linear valve motion in order to seal an outlet with a uniform seal about the periphery. Moreover, the linear motion eliminates the friction related to sliding described in the prior art and thereby reduces the risk of failure or fatigue. Additionally, the invention structurally baffles a hot or cold airstream towards the outlet to facilitate air mixing in order to achieve the desired outlet temperature.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a cross-sectional view of an embodiment of an HVAC system;

FIG. 2 is a perspective cross-sectional view of another embodiment of the invention illustrating a pair of plate valves;

FIG. 3 is a fragmentary view of the embodiment of FIG. 2 illustrating the shaft, valves and guide;

FIG. 4 is a fragmentary view of the embodiment of FIG. 3 illustrating the valve in a closed position;

FIG. 5 is a fragmentary view of the embodiment of FIG. 3 illustrating the valve in an open position;

FIG. 6 is fragmentary cross-sectional view of the embodiment shown in FIG. 3; and

FIG. 7 is an alternative embodiment of the embodiment of an HVAC system.

### DETAILED DESCRIPTION OF THE INVENTION

A plurality of different embodiments of the invention are shown in the Figures of the application. Similar features are shown in the various embodiments of the invention. Similar features are structured similarly, operate similarly, and/or have the same function unless otherwise indicated by the drawings or this specification. Furthermore, particular features of one embodiment can replace corresponding features in another embodiment unless otherwise indicated by the drawings or this specification.

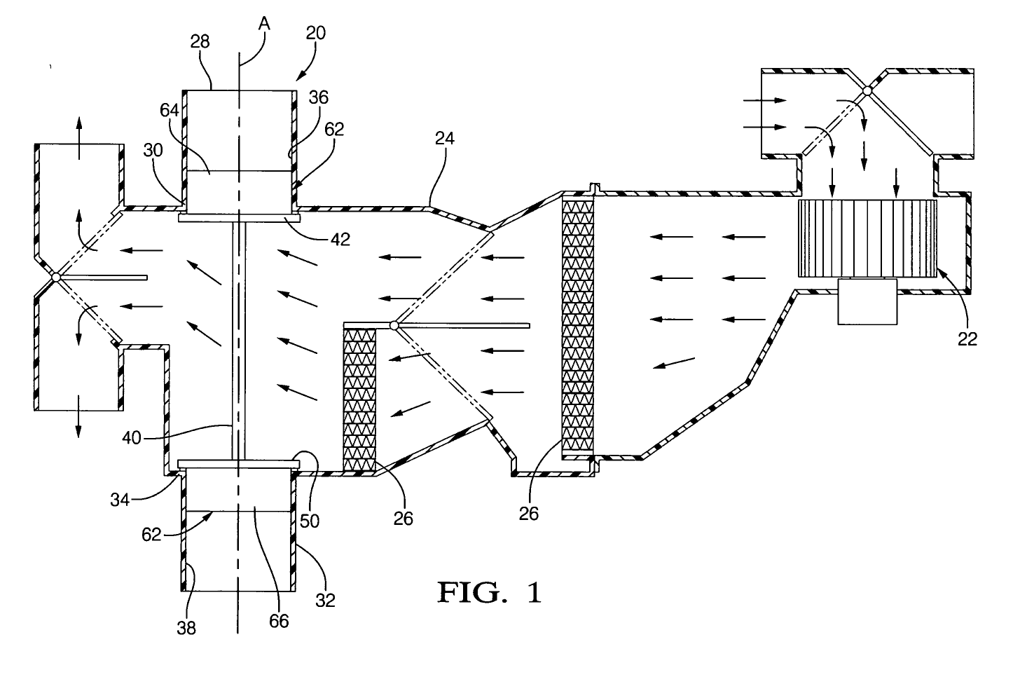

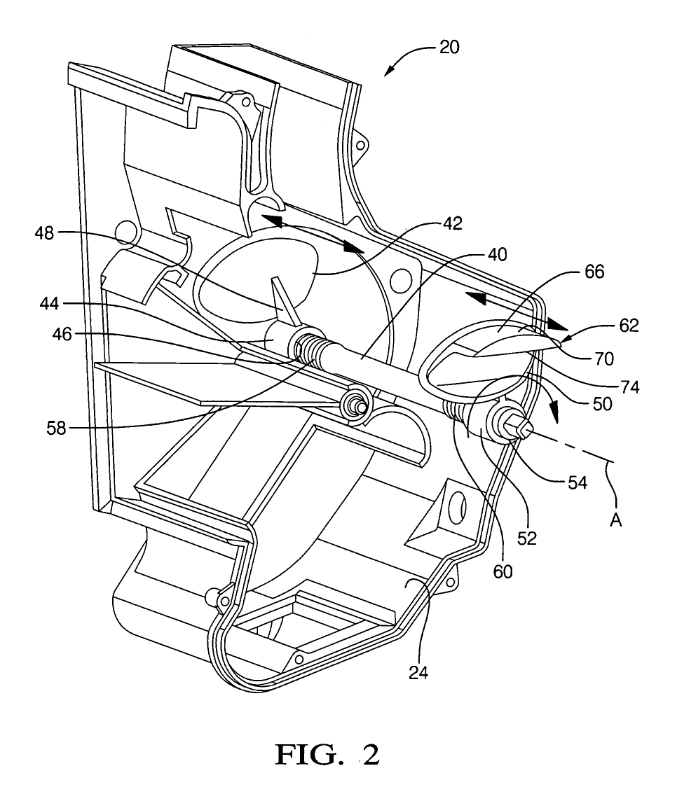

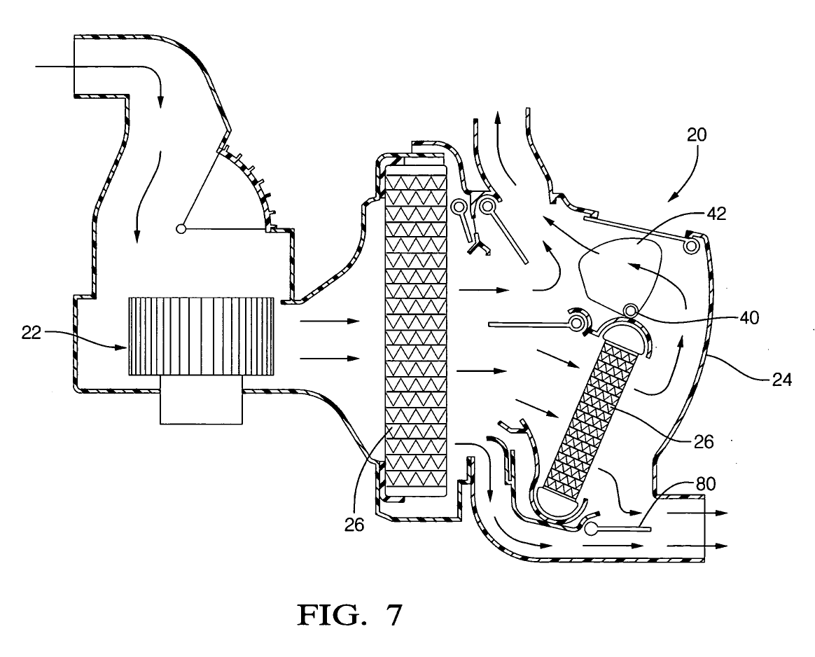

A climate control or HVAC system 20 can be disposed in a vehicle to control conditions associated with air inside a passenger compartment of a vehicle. The exemplary climate control system 20 includes a blower 22 for blowing air through the housing 24 and a plurality of heat exchangers 26 for heating and cooling the air in the housing 24, as shown in FIGS. 1 and 7.

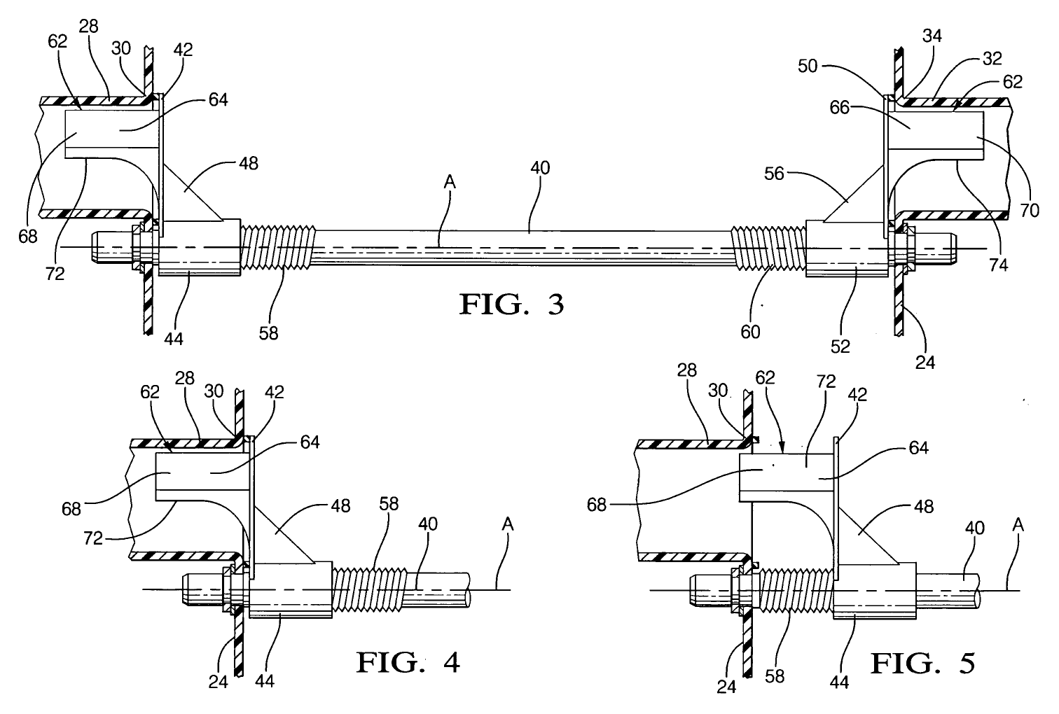

Referring to FIGS. 3-6, the housing 24 defines a first outlet 28 having a first outer periphery 30 and a second outlet 32 having a second outer periphery 34. The outlets 28, 32 oppositely face one another. The first outer periphery 30 may have a fan-like shape extending radially, but is not limited to this geometry, and defines a first contoured surface 36. The second outer periphery 34 may similarly have a fan-like shaped, but is not limited to this geometry, and defines a second contoured surface 38 equal in size and shape to the first contoured surface 36.

A shaft 40 is rotatably supported by the housing 24 outside the peripheries 30, 34 of the outlets 28, 32 and extends along an axis A. The shaft 40 extends between and perpendicular to the peripheries 30, 34 of the outlets 28, 32.

The assembly 20 includes a first plate valve 42 for covering the first outer periphery 30 of the first outlet 28 in a closed position and axially movable to an open position. FIGS. 4 and 5 illustrate the first plate valve 42 in the open and closed positions respectively. The first plate valve 42 includes a first bushing 44 defining a first interior surface 46 surrounding the shaft 40. The first valve 42 also includes a first plate extending radially from the first bushing 44 in a fan-like shape for sealing the first periphery 30 of the first outlet 28. A first reinforcing web 48 interconnects the first bushing 44 and the first plate for reinforcing the first plate on the first bushing 44.

A second plate valve 50 is included for covering the second outer periphery 34 of the second outlet 32 in a closed position and movable to an open position. The second valve 50 includes a second bushing 52 defining a second interior surface 54 surrounding the shaft 40. The second valve 50 also includes a second plate extending radially from the second bushing 52 in a fan-like shape for sealing the second periphery 34 of the second outlet 32. A second reinforcing web 56 interconnects the second bushing 52 and the second plate for reinforcing the second plate on the second bushing 52.

The assembly 20 is distinguished by the shaft 40 having oppositely threaded first and second sections 58, 60 disposed at opposite ends of the shaft 40 as best shown in FIG. 3. The interior surfaces 46, 54 of the bushings 44, 52 are oppositely threaded, and the first interior surface 46 of the first bushing 44 is in threaded engagement with the first section 58 of the shaft 40, as illustrated in FIG. 3. Likewise, the second interior surface 54 of the second bushing 52 is in threaded engagement with the second section 60 of the shaft 40. The threaded engagements move the plate valves 42, 50 axially toward one another in response to rotation of the shaft 40 in a first direction and move the plate valves 42, 50 axially away from one another in response to rotation of the shaft 40 in a second direction opposite to the first direction.

The assembly 20 includes a guide 62, generally indicated, for limiting rotation of the valves 42, 50 relative to the axis A in response to rotation of the shaft 40. The first valve 42 may include a first guide plate 64 and the second valve 50 may include a second guide plate 66 to define the guide 62.

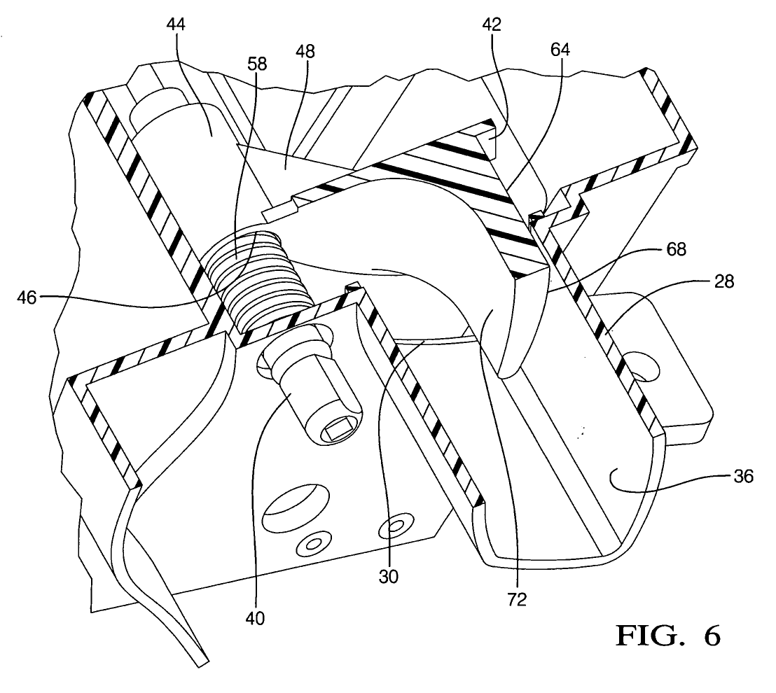

As best shown in FIG. 6, the first guide plate 64 defines a first upper surface 68 and the second guide plate 66 defines a second upper surface 70. The first upper surface 68 of the first guide plate 64 extends parallel to and through the first contoured surface 36 of the first outlet 28 for limiting rotation of the first valve 42 relative to the axis A in response to rotation of the shaft 40. The first guide plate 64 defines a first lower surface 72 which has a contoured shape extending parallel to the axis A for directing radial air flow axially through the first outlet 28 in the open position. Similarly, the second upper surface 70 of the second guide plate 66 extends parallel to and through the second contoured surface 38 of the second outlet 32 for restricting rotation of the second valve 50 about the axis A in response to rotation of the shaft 40. The second guide plate 66 defines a second lower surface 74 which has a contoured shape extending parallel to the axis A for directing radial air flow axially through the second outlet 32 in the open position. The upper surfaces 68, 70 of the guide plates 64, 66 profile the contoured surfaces of the outlet and the lower surfaces 72, 74 are flat, however the surfaces of the guide plates 64, 66 are not limited to this geometry.

FIG. 7 illustrates an alternative embodiment of the HVAC system 20 having a plurality of rotary valves 80 and detailing an arrangement where the plate valves 42, 50 would be able to catch the air flow and redirect the path of the air flow into the outlets 28, 32.

While the invention has been described with reference to an exemplary embodiment, it will be understood by those skilled in the art that various changes may be made and equivalents may be substituted for elements thereof without departing form the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An assembly for controlling air flow in an HVAC system comprising;
a housing defining a first outlet having a first outer periphery,
a shaft rotatably supported by said housing outside said first periphery of said first outlet and extending along an axis,
a first plate valve for covering said first outer periphery of said first outlet in a closed position and movable away from said first outlet along said axis to an open position,
said first plate valve having a first interior surface surrounding said shaft and extending radially from said first interior surface for sealing said first periphery of said first outlet,
said shaft having a threaded first section,
said interior surface being threaded and in threaded engagement with said first section of said shaft for moving said first plate valve axially away from said first outlet in response to rotation of said shaft in a first direction and moving said first plate valve axially toward said first outlet in response to rotation of said shaft in a second direction opposite to said first direction.

2. An assembly as set forth in claim 1 including a guide for limiting rotation of said first valve relative to said axis in response to rotation of said shaft.

3. An assembly as set forth in claim 2 wherein said housing defines a second outlet having a second outer periphery and oppositely facing said first outlet.

4. An assembly as set forth in claim 3 including a second plate valve having a second interior surface for covering said second outer periphery of said second outlet in a closed position and movable axially of said shaft to an open position.

5. An assembly as set forth in claim 4 wherein said shaft has a second section oppositely threaded and axially spaced from said first section.

6. An assembly as set forth in claim 5 wherein said interior surfaces are oppositely threaded from one another, and
wherein said second interior surface is in threaded engagement with said second section of said shaft for moving said plate valves axially toward one another in response to rotation of said shaft in said first direction and moving said plate valves axially away from one another in response to rotation of said shaft in said second direction.

7. An assembly as set forth in claim 6 wherein said first outer periphery defines a first contoured surface of said first outlet and said second outer periphery defines a second contoured surface equal in size and shape to said first contoured surface of said first periphery.

8. An assembly as set forth in claim 7 wherein said guide includes a first guide plate defining a first upper surface extending axially from said first plate valve for restricting rotation of said first valve about said axis in response to rotation of said shaft and a second guide plate defining a second upper surface extending axially from said second plate valve for restricting rotation of said second valve about said axis in response to rotation of said shaft.

9. An assembly as set forth in claim 8 wherein said first guide plate extends through said first contoured surface of said first outlet and said second guide plate extends through said second contoured surface of said second outlet.

10. An assembly as set forth in claim 9 wherein said first upper surface of said first guide plate is parallel to said first contoured surface and said second upper surface of said second guide plate is parallel to said second contoured surface.

11. An assembly as set forth in claim 8 wherein said first guide plate defines a first lower surface having a contoured shape extending parallel to said axis for directing air flow through said first outlet in the open position and said second guide plate defines a second lower surface having a contoured shape extending parallel to said axis for directing air flow through said second outlet in the open position.

12. An assembly as set forth in claim 6 wherein said outer peripheries each have a fan-like shape.

13. An assembly as set forth in claim 6 wherein said first plate valve includes a first bushing defining said first interior surface and a first plate extending radially from said first bushing and said second plate valve includes a second bushing defining said second interior surface and a second plate extending radially from said second bushing.

14. An assembly as set forth in claim 13 wherein said plates each extend radially in a fan-like shape from said shaft.

15. An assembly as set forth in claim 13 wherein said first plate valve includes a first reinforcing web interconnecting said first bushing and said first plate for reinforcing said first plate on said first bushing and said second plate valve includes a second reinforcing web interconnecting said second bushing and said second plate for reinforcing said second plate on said second bushing.

16. An assembly as set forth in claim 6 wherein said shaft is supported between and perpendicular to said peripheries of said outlets.

17. An assembly as set forth in claim 6 wherein said threaded first and second sections of said shaft are disposed at opposite ends of said shaft.

18. An assembly as set forth in claim 6 including a blower assembly for blowing air through said housing.

19. An assembly as set forth in claim 18 including at least one heat exchanger for heating and cooling the air in said housing.

20. An assembly as set forth in claim 2 wherein said guide includes a first guide plate defining a first upper surface extending axially from said first plate valve for engaging said first outlet and restricting rotation of said first valve about said axis in response to rotation of said shaft.

21. An assembly as set forth in claim 20 wherein said first outer periphery defines a first contoured surface and said first guide plate extends parallel to and through said first contoured surface of said first outlet.

22. An assembly as set forth in claim 21 wherein said first upper surface of said first guide plate is parallel to said first contoured surface.

23. An assembly as set forth in claim 20 wherein said first guide plate defines a first lower surface having a contoured shape extending parallel to said axis for directing air flow through said first outlet in the open position.

24. An assembly as set forth in claim 2 wherein said first outer periphery has a fan-like shape.

25. An assembly as set forth in claim 2 wherein said first plate valve includes a first bushing disposed about said first interior surface and a first plate extending radially from said first bushing.

26. An assembly as set forth in claim 25 wherein said first plate extends radially in a fan-like shape from said shaft.

27. An assembly as set forth in claim 25 wherein said first plate valve includes a first reinforcing web interconnecting said first bushing and said first plate for reinforcing said first plate on said first bushing.

28. An assembly as set forth in claim 2 wherein said shaft is supported perpendicular to said first periphery of said first outlet.

29. An assembly as set forth in claim 2 including a blower assembly for blowing air through said housing.

30. An assembly as set forth in claim 29 including at least one heat exchanger for heating and cooling the air in said housing.

31. An assembly for controlling air flow in an HVAC system comprising;
a housing defining a first outlet having a first outer periphery and a second outlet having a second outer periphery and oppositely facing said first outlet,
a blower for blowing air through said housing,
a heat exchanger for heating and cooling the air in said housing,
said first outer periphery being fan-shaped to define a first arc,
said second outer periphery being fan-shaped to define a second arc equal in size and shape to said first arc,
a shaft rotatably supported by said housing outside said peripheries of said outlets and extending along an axis between and perpendicular to said peripheries of said outlets,
a first plate valve for covering said first outer periphery of said first outlet in a closed position and movable axially away from said first outlet the to an open position,
a second plate valve for covering said second outer periphery of said second outlet in a closed position and movable axially away from first outlet to an open position,
said first plate valve including a first bushing defining a first interior surface surrounding said shaft and a first plate extending radially from said first bushing in a fan-like shape for sealing said first periphery of said first outlet and a first reinforcing web interconnecting said first bushing and said first plate for reinforcing said first plate on said first bushing,
said second valve including a second bushing defining a second interior surface surrounding said shaft and a second plate extending radially from said second bushing in a fan-like shape for sealing said second periphery of said second outlet and a second reinforcing web interconnecting said second bushing and said second plate for reinforcing said second plate on said second bushing,
said first plate valve including a first guide plate defining a first upper surface extending parallel to and through said first contoured surface of said first outlet for limiting rotation of said first valve relative to said axis in response to rotation of said shaft and a first lower surface having a contoured shape extending parallel to said axis for directing air flow through said first outlet in the open position,
said second plate valve including a second guide plate defining a second upper surface extending parallel to and through said second contoured surface of said second outlet for limiting rotation of said second valve about said axis in response to rotation of said shaft and a second lower surface having a contoured shape extending parallel to said axis for directing air flow through said second outlet in the open position,
said shaft having oppositely threaded first and second sections disposed at opposite ends of said shaft,
said interior surfaces of said bushings being oppositely threaded, and
said first interior surface of said first bushing being in threaded engagement with said first section of said shaft and said second interior surface of said second bushing being in threaded engagement with said second section of said shaft for moving said plate valves axially toward one another in response to rotation of said shaft in a first direction and moving said plate valves axially away from one another in response to rotation of said shaft in a second direction opposite to said first direction.
